(19) United States
(12) Patent Application Publication
(10) Pub. No.: US 2004/0120711 A1
(43) Pub. Date: Jun. 24, 2004

(54) Optical transmission system with variable network limits

(76) Inventors: J?ouml;rg-Peters Elbers, Munchen (DE); Uwe Fischer, M?uuml;nchen (DE); Christoph Glingener, Feldkirchen-Westernham (DE); Manfred Lobjinski, M?uuml;nchen (DE)

Correspondence Address: BELL, BOYD & LLOYD, LLC, P. O. BOX 1135, CHICAGO, IL, 60690-1135, US

(21) Appl. No.: 10/472,864

(22) PCT Filed: Mar. 11, 2002
(86) PCT No.: PCT/DE02/00856

(30) Foreign Application Priority Data
Mar. 20, 2001 (DE) 101 13 563.7
Dec. 3, 2001 (DE) 101 59 263.9

(51) Int. Cl. H04B 10/24

(52) U.S. Cl. 398/41

(57) ABSTRACT

An optical transmission system is provided in which the signals are transmitted at different wavelengths between terminals of a transmission network and only those signals are regenerated whose quality parameters require regeneration. A management system, when deciding about the location of regeneration, takes the design and the properties of the transmission network including the existing regeneration possibilities and the possible routing into consideration.

The invention relates to an optical transmission system according to the preamble of Claim 1.

The demand for transmission capacity is increasing all the time. With the existing optical transmission networks, the transmission capacity is increased through the use of a plurality of wavelengths or channels. Wavelength multiplex systems WDM and wavelength systems with tighter channel spacings DWDM (Dense Wavelength Division Multiplex) preferably use sharable components and a common amplifier for signal distortion of multiple channels. By means of this signal equalization and optical amplification it is already possible to bridge relatively large transmission distances (spans) without the need for a so-called 3R regeneration in which, apart from the amplitude, the timing and the pulse shape are regenerated. Currently this regeneration is still performed for each channel individually following the conversion of the optical transmission signals into electrical signals. The regenerated electrical signals are subsequently converted back into optical signals.

With the known network structure, a common regeneration of all signals is always performed in one terminal. These networks therefore consist, as it were, of a plurality of point-to-point connections. In particular with a connection between subnetworks, all the signals essentially exhibit the same signal parameters.

For cost reasons the trend is toward a purely photonic network in which the tapping off and insertion of signals (ADD-DROP function) as well as a through-connection of optical signals for use of different trunks, referred to as the cross-connect method, are performed without a prior conversion into electrical signals.

The object of the invention is to specify an optical transmission system in which a small overhead is required for signal regeneration.

This object is achieved by a transmission system according to Claim 1.

Advantageous embodiments of the invention are specified in the subclaims.

Particularly advantageous in the transmission system according to the invention is that only those signals are regenerated in which regeneration is necessary on account of the signal quality or because of quality parameters. This method is particularly advantageous when a high proportion of the connections is variable. By incorporation of the entire network structure, including its regeneration capabilities, optimal connections can be realized with a minimum number of regenerations. Provision must of course be made as early as during the network planning stage to ensure an adequate number of regenerators. As the simplest and most inexpensive type of regeneration, only a signal amplification can be performed. Equally, with a 3R generation, amplitude, phase and pulse shape can be regenerated.

The network can be considerably simplified if the parameters (level, distortion) for the signals injected into the network are identical.

If, in addition, the signals exhibit a uniform quality at certain points in the network, for example when being injected, then the signal-to-noise ratio can be used as the determining signal parameter for the signal quality. This is measured and reported to the management system.

The latter has available to it the system data for the entire network structure as well as data on active and possible connections. It can therefore decide which connections are switched and at which point a regeneration is to take place.

Error-correcting codes are used in order to reduce the error rate or to extend the regenerator-free transmission sections (spans). The decoders automatically provide statistics concerning the bit error rate, which can be evaluated by the network management system instead of the signal-to-noise ratio or similar criteria (e.g. Q factor). Additional other criteria can also be used to determine the signal quality.

As a particularly inexpensive variant in place of the measurement, the signal quality can be calculated based on the system data for each location.

In order to simplify the network planning it is useful if the signal amplitudes are amplified or attenuated to the same value when multiple signals are combined in one terminal.

An exemplary embodiment of the invention is explained in more detail below with reference to the figures, in which:

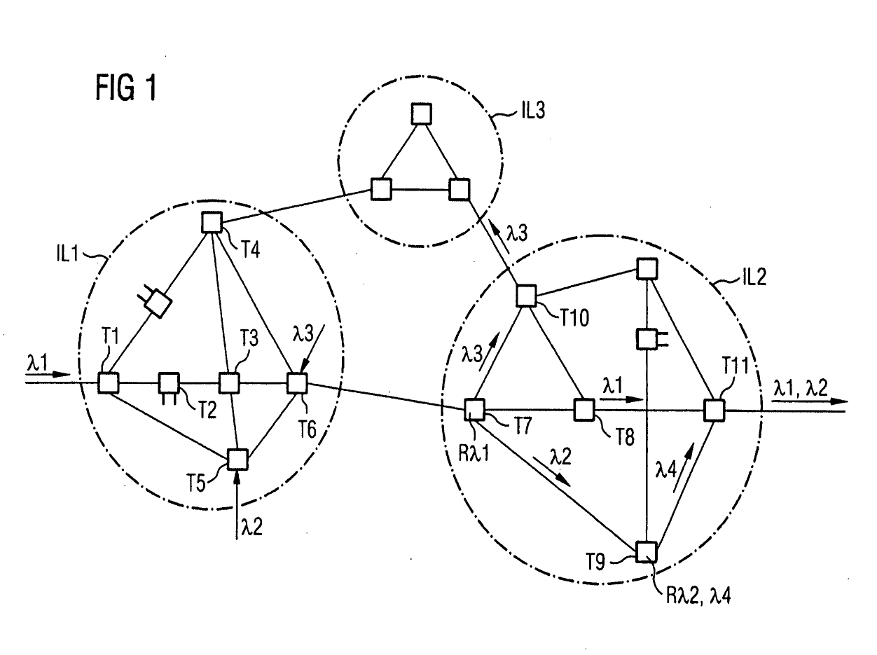

FIG. 1 shows an optical transmission network,

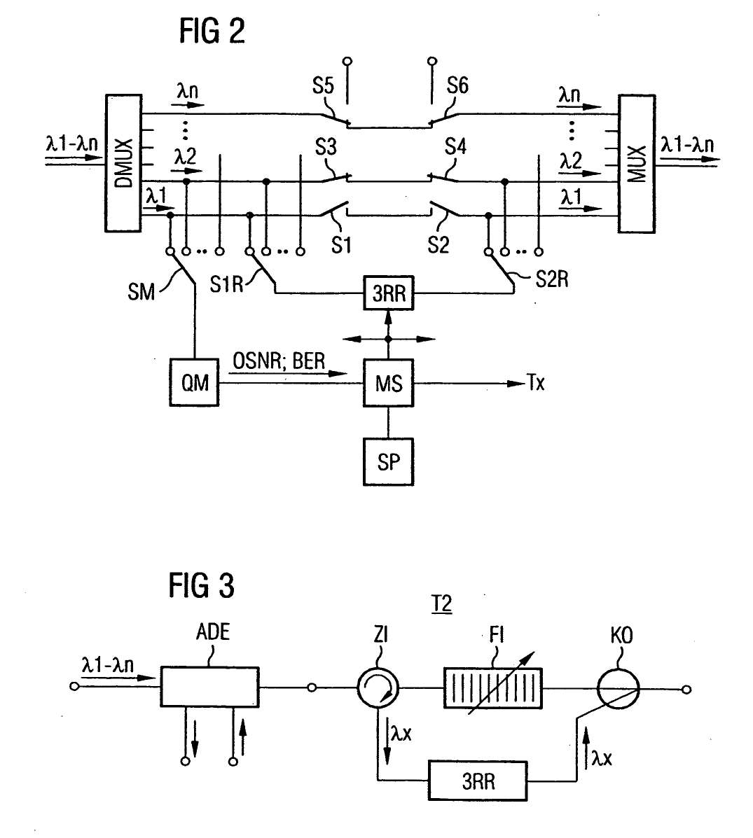

FIG. 2 shows an exemplary embodiment of a terminal having a regenerator function and

FIG. 3 shows an advantageous embodiment of an ADD-DROP regenerator terminal.

FIG. 1 shows an optical transmission network with three optical subnetworks IL1, IL2 and IL3, so-called optical islands. In a traditional transmission system the signal parameters for signals to be transmitted and for received signals would be precisely defined at least at the outer limits. In the system according to the invention these limits no longer exist (floating optical islands; floating borders); there are no fixed limits for the regeneration of an optical signal. The optical subnetworks IL1-IL3 each contain a number of terminals T1, T2, . . . , of which only the terminals necessary for the explanation are designated. These terminals can include ADD-DROP functions, switching functions and/or regenerator functions. In the first optical subnetwork IL1, terminals T1, T5, T6, T4 are connected in a ring configuration and terminals T1 and T6, T4 and T5 are again interconnected via the cross-connector T3. Less complex structures, such as a simple ring network or a star network, are also possible.

A signal λ1 routed via the first terminal T1 is for example already dropped off in an ADD-DROP terminal T3. In place of the dropped signal λ1, a distortion-free new signal λ1 with the same wavelength is injected and switched through to terminal T6, for example a photonic cross-connector. A second optical signal λ2 is injected for example into a terminal T5 which has connections to terminals T1 and T6. In this case signal λ2 is also routed to terminal T6. A third signal λ3 to be transmitted is also injected into this terminal.

The signals λ1, λ2 and λ3 are combined, together with further signals, into a multiplex signal and transmitted to terminal T7 in the second subnetwork IL2. Before being multiplexed, the signals can all be raised to the same level. Even when this is done, the signal-to-noise ratios of the signals may be different due to the different lengths and possible different quality of the transmission spans. Even if no regeneration was necessary in the first subnetwork IL, a check must be made to determine whether the multiplex signal can be transmitted as far as terminal T7 in the second subnetwork EL without prior regeneration. This is intended to be the case here. A regeneration of the first signal λ1 is however necessary in terminal T7, as the functional designation Rλ1 is intended to indicate. The (3R) generated signal λ1 is then transmitted via a terminal T8 to terminal T11, where it is either dropped off or if appropriate can be forwarded after being newly regenerated. In this case the second optical signal λ2 is transmitted via a different connection to terminal T9, where it is regenerated and likewise forwarded to terminal T11. In terminal T9, a conversion of the wavelength into wavelength λ4 is also necessary since wavelength λ2 is already occupied on the transmission span to terminal T11. The third optical signal λ3 is transmitted without regeneration via terminals T7 and T10 to terminal T12 in the third subnetwork IL3.

A similar procedure applies to the transmission in the reverse direction. A bidirectional connection can use the same wavelengths on a further fiber or other wavelengths (or also other traffic channels) on the same fibers for transmission. FIG. 2 shows in schematic form a part of a terminal in which signals can be switched through, regenerated or dropped off and inserted. The received multiplex signal λ1-λn is divided up into individual signals (channels) λ1-λn in the demultiplexer DMUX.

The quality of the optical signals λ1-λn is determined in a quality meter QM, for example a measuring device for determining the signal-to-noise ratio OSNR as a possible quality parameter. With a transmission protected by an error-detecting or error-correcting code, the bit error rate BER can also be measured as a quality parameter. Further coding-independent methods for determining the signal quality based on shifting the sampling threshold and/or the sampling time also come into consideration. The Q-factor in particular is assuming an increasingly important role as a quality criterion.

All signals λ1 through λn can be checked in turn in only one measuring device by means of a measuring switch SM. In addition to the signal quality, the signal level is usually taken into account as a further quality characteristic. However, if the levels of all the signals in the terminals are brought to the same value, the signal level can be ignored in a favorably designed network.

A particularly inexpensive alternative for measuring the signal quality is based on the signals being of identical quality and on the same level when they enter the network (or from a measuring position). The signal quality or the quality parameters can be calculated at any terminal (and even for any arbitrary position) on the basis of the network parameters.

The signal parameters of the individual signals measured or calculated at the terminals are supplied to a management system MS which has access to the system parameters SP, the structure of the transmission network, the terminals, the quality of the connection routes, regeneration capabilities as well as current existing and possible connections. The management system determines whether the corresponding optical signals λ1 or λ2, for example, are switched through via the switches S1-S4 or whether one of these signals, in this case λ1, is preferably supplied to a 3R regenerator (amplitude, timing, pulse shape, reamplifying, retiming, reshaping) for 3R regeneration via a switch S1R. At the same time a conversion of the wavelength can also be performed here. A plurality of switches S1, S2, S3, S4, S1R and S2R are provided in order to enable an optional regeneration of one of a plurality of signals in a terminal according to FIG. 2. The regenerated signal is supplied to a multiplexer MUX via a further switch S2R. By means of said switch the optical signals are combined once again and forwarded as a multiplex signal λ1-λn.

For some of the signals, represented in this case by the signal λn, only a cross-connect or an ADD-DROP function via switch S4 and S5 is provided.

The switches can be regarded as a simplified cross-connect device (cross connector).

In a 3R regeneration, economic considerations determine whether switchable regenerators or a plurality of different regenerators are used in relation to the wavelength. This also applies if different data rates are used for transmission.

If a number of management systems are provided, then the determined quality criteria are transferred to the newly responsible system at the “management borders” or measured in the “new network”. Further terminals Tx are controlled or further management computers informed via a service channel.

FIG. 3 shows an advantageous variant of a regenerator terminal T2. This contains in the form of the ADD-DROP device ADE the series circuitry of a circulator ZI, a tunable filter FI and an optical coupler (filter) KO. Out of the signals λ1-λn to be transmitted, (at least) one signal λx can be dropped via ADD-DROP terminals AA, DA and supplied to a 3R regenerator 3RR. This terminal can also be connected in series with preferably identically designed ADD-DROP devices ADE.

Reference characters

λ1 Optical signal

λ1-λn Multiplex signal

T1, T2, T3, . . . Terminal

T2 ADD-DROP terminal

IL1, IL2, . . . Subnetworks, “optical islands”

QM Signal parameter measuring device

MS Management system

SP System parameter

TX

D Transmission network

MUX Multiplexer

DMUX Demultiplexer

3RR 3R regenerator

S1-S6, S1R, S2R Optical switches

1. An optical transmission system, wherein signals (λ1, λ2, λ3, . . . ) with different wavelengths are transmitted between terminals (T1, T2, T3, . . . ) of a transmission network (IL1, IL2, IL3) and wherein regenerators (3RR) are provided,
characterized in that
only signals (λ1, λ2) having quality parameters that require regeneration are regenerated by the regenerators (3RR).

2. The optical transmission system according to claim 1,
characterized in that,
in addition to the location-dependent quality parameter of a signal (λ1, λ2), its possible further alternate routings to a destination terminal (T12) and existing regeneration capabilities are taken into account in the decision about a regeneration and its associated location.

3. The optical transmission system according to claim 1 or 2,
characterized in that
the quality parameters of a signal (λ1, λ2) injected into the transmission network (IL1, IL2, IL3) are predetermined or measured and that its quality parameters are determined mathematically when passing through the transmission network (IL1, IL2, IL3) from an add terminal (T1) or from a terminal (T7) performing a regeneration en route to the destination terminal (T12) based on known network parameters and taken into account in the decision about a regeneration and its associated location.

4. The optical transmission system according to claim 1 or 2,
characterized in that
measuring devices (QM) for determining the quality parameters are provided in the terminals (T1, T2, . . . ).

5. The optical transmission system according to one of the preceding claims,
characterized in that
all the signals (λ1, λ2, λ3) injected into the transmission network (IL1, IL2; L3) have identical quality parameters or at least one identical quality parameter, the amplitude.

6. The optical transmission system according to one of the preceding claims,
characterized in that
signals (λ1, λ2, λ3) in terminals are brought to the same level during multiplexing.

7. The optical transmission system according to one of the preceding claims,
characterized in that
the quality parameters of a signal are determined or measured when the signal (λ1, λ2, λ3) crosses from one subnetwork (IL1) into another subnetwork (IL2) or from one management domain into another management domain.

8. The optical transmission system according to one of the preceding claims,
characterized in that
the signal-to-noise ratio of a signal (λ1, λ2, λ3) or a quality criterion dependent on this signal-to-noise ratio is determined or measured as a quality parameter.

9. The optical transmission system according to one of the preceding claims,
characterized in that
the bit error rate (BER) of a signal (λ1, λ2, λ3) or a criterion dependent on this bit error rate is determined or measured as a quality parameter.

10. The optical transmission system according to claim 4,
characterized in that
regenerator devices (3RR) are provided in the terminals (T1, T2, . . . ), said regenerator devices being connectable via an ADD-DROP equipment (ADE) or cross-connect equipment (S1-S4, S1R, S2R).
